(19) United States
(12) Patent Application Publication
(10) Pub. No.: US 2017/0093227 A1
(43) Pub. Date: Mar. 30, 2017

(54) CORROSION RESISTANT OPTICAL CONNECTOR WITH ACCOMPANYING CIRCUITRY

(71) Applicant: APPLE INC., Cupertino, CA (US)

(72) Inventors: Alvin J. Hilario, Cupertino, CA (US); Enwen Pang, Cupertino, CA (US); Jason J. Huey, Cupertino, CA (US)

(73) Assignee: APPLE INC., Cupertino, CA (US)

(21) Appl. No.: 14/871,825

(22) Filed: Sep. 30, 2015

(51) Int. Cl. H02J 50/30; H04B 10/40; H04B 10/50; H04B 10/25; G02B 6/32; G02B 6/42

(52) U.S. Cl. CPC H02J 50/30; G02B 6/325; G02B 6/4292; G02B 6/4246; H04B 10/501; H04B 10/25; H04B 10/40

(57) ABSTRACT

Connector receptacles and inserts that may be used to transfer power and data and may be corrosion resistant. One example may provide a connector system including a connector receptacle and a connector insert where data and power are transferred via fiber-optic windows. Ends of the fiber-optic windows may be used as optical contacts. The ends of the fiber-optic windows may be surrounded on their sides by an optical gasket. The fiber-optic windows and optical gasket may be corrosion resistant.

### BACKGROUND

The number of types of electronic devices that are commercially available has increased tremendously the past few years and the rate of introduction of new devices shows no signs of abating. Devices, such as tablet, laptop, netbook, desktop, and all-in-one computers, smart phones, storage devices, wearable devices, portable media players, navigation systems, remote controls, monitors, and others, have become ubiquitous.

These electronic devices often include one or more connector receptacles though which they may provide and receive power and data. This power and data may be conveyed over cables that may include wire conductors, fiber-optic cables, or some combination of these or other conductors. Cable assemblies may include a connector insert at each end of a cable. The connector inserts may be inserted into receptacles in the communicating electronic devices in order to form power and data paths between the devices.

These connector inserts and receptacles may include metallic contacts for transferring power and data. But metallic contacts may corrode due to electrochemical migration that may occur as voltages are applied. This corrosion may degrade functionality and appearance of the contacts, which may be particularly important for contacts that are formed at a surface of an electronic device. To avoid such corrosion, the contacts may be formed or plated using expensive and rare metals. But these contacts may become marred with use. This wear may damage the protective plating on the contacts, exposing them to further corrosion.

Data may also be transferred using wireless radio frequency (RF) connections. But such RF connections are subject to interference and signal drop-out. This may be particularly true in some situations, such as during device manufacturing when a device is being initially programmed or updated. Also, wireless RF signals, while useful for data transfers, are poor at delivering useful amounts of power.

Thus, what is needed are connector receptacles and inserts that may be used to transfer power and data and may be corrosion resistant.

### SUMMARY

Accordingly, embodiments of the present invention may provide connector receptacles and inserts that may be used to transfer power and data and may be corrosion resistant. An illustrative embodiment of the present invention may provide a connector system including a connector receptacle and a connector insert where data and power are transferred over fiber-optic cables or windows, referred to here as fiber-optic windows. Ends of the fiber-optic windows may be used as optical contacts. The fiber-optic windows may be corrosion resistant. An optical gasket may be formed or placed around ends of the fiber-optic windows to prevent moisture leakage into a device housing the connector receptacle or into the connector insert.

In other embodiments of the present invention, the fiber-optic windows may terminate at or near one or more transparent coverings or lenses, which may be used as optical contacts. The transparent coverings or lenses may be corrosion resistant. An optical gasket may be formed or placed around sides of the coverings or lenses to prevent moisture leakage. In various embodiments of the present invention, each fiber-optic window in a connector receptacle or connector insert may terminate at or near a separate covering or lens, or one or more, or all, of the fiber-optic windows may terminate at or near a single covering to further prevent moisture leakage. The one or more coverings may include transparent areas or lenses arranged to be at least approximately adjacent to ends of the fiber-optic windows. The one or more coverings may be opaque in areas between and around terminating locations of the fiber-optic windows in order to reduce light scattering among the optical contacts. The one or more coverings may be sealed by one or more optical gaskets between the one or more coverings and a device enclosure housing the connector receptacle or the connector insert.

Another illustrative embodiment of the present invention may provide a connector system including a connector receptacle and a connector insert. The connector insert may provide a first fiber-optic data path to the connector receptacle, and the connector receptacle may provide a second fiber-optic data path to the connector insert. The first and second fiber-optic data paths may share a physical fiber-optic window, or separate fiber-optic windows may be used. In some embodiments of the present invention where a single fiber-optic window is used, signals may be alternately provided by the connector insert and the connector receptacle in a half-duplex mode. In other embodiments of the present invention where a single fiber-optic window is used, signals provided by the connector insert and the connector receptacle may be conveyed using different frequencies of light and data may be transferred in a full-duplex mode. In still other embodiments of the present invention, data may be unidirectional, where data is provided from the connector receptacle to the connector insert or data is provided from the connector insert to the connector receptacle.

In these and other embodiments of the present invention, power may be transferred using fiber-optics. For example, light may be provided by the connector insert to the connector receptacle. The connector receptacle may receive the light from the connector insert and convert it into charging current that may provide power to a transceiver and other circuitry in the connector receptacle. The charging current may also be used to charge a battery. In other embodiments of the present invention, power may be provided from the connector receptacle to the connector insert using this or similar techniques. In still other embodiments of the present invention, power may be provided from either connector to the other, depending on which side has power available to transfer.

In various embodiments of the present invention, light used for power transfer may be provided using a light emitting device such as light-emitting diode (LED), laser, infrared transmitter, or other light source. The light for power transfer may be received and converted to electrical current using a light-receiving device such as a photovoltaic cell or other appropriate device.

Another illustrative embodiment of the present invention may provide a connector insert and associated circuitry having a power supply, a light-emitting device, a fiber-optic transceiver, one or more fiber-optic windows, and one or more electrical signal paths. The power supply may be applied to the light-emitting device, which may provide light over a first fiber-optic window. The fiber-optic transceiver may convert between electrical signals on the one or more electrical signal paths and fiber-optic signals on the one or more fiber-optic windows. Instead of a fiber-optic transceiver, other embodiments of the present invention may employ fiber-optic transmitters or receivers for unidirectional communication. The electrical signal paths may be single-ended or differential.

Another illustrative embodiment of the present invention may provide a connector receptacle and associated circuitry having a battery, battery control logic, data input and output circuitry, a memory, a light-receiving device, a fiber-optic transceiver, one or more fiber-optic windows, and one or more electrical signal paths between the data input and output circuitry and the fiber-optic transceiver. The data input and output circuitry may receive data from and write data to the memory. Light may be received by the light-receiving device. The light-receiving device may convert the received light into a current to power the data input and output circuit and memory, and optionally, to charge the battery. The fiber-optic transceiver may convert between electrical signals on the one or more electrical signal paths and fiber-optic signals on the one or more fiber-optic windows. Instead of a fiber-optic transceiver, other embodiments of the present invention may employ fiber-optic transmitters or receivers for unidirectional communication. The electrical signal paths may be single-ended or differential.

In various embodiments of the present invention, the fiber-optic windows, the one or more transparent coverings or lenses, and other optically conductive components may be formed using sapphire, polycarbonate, glass or other material. The optical gaskets and other optically nonconductive components may be formed of silicone, plastic, or other material. These may be formed by injection molding or other process. Electrically conductive portions of connector receptacles may be formed by stamping, metal-injection molding, machining, micro-machining, printing, 3-D printing, or other manufacturing process. The electrically conductive portions may be formed of stainless steel, steel, copper, copper titanium, phosphor bronze, or other material or combination of materials. They may be plated or coated with nickel, gold, or other material. Nonconductive portions may be formed using injection or other molding, 3-D printing, machining, or other manufacturing process. The nonconductive portions may be formed of silicon or silicone, rubber, hard rubber, plastic, nylon, liquid-crystal polymers (LCPs), ceramics, or other nonconductive material or combination of materials.

Embodiments of the present invention may provide connector receptacles that may be located in, and may connect to, various types of devices, such as portable computing devices, tablet computers, desktop computers, laptops, all-in-one computers, wearable computing devices, smart phones, storage devices, portable media players, navigation systems, monitors, power supplies, adapters, remote control devices, chargers, and other devices. These connector receptacles may provide pathways for signals that are compliant with various standards such as Universal Serial Bus (USB), High-Definition Multimedia Interface® (HDMI), Digital Visual Interface (DVI), Ethernet, DisplayPort, Thunderbolt™, Lightning™, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. In various embodiments of the present invention, these interconnect paths provided by these connector receptacles may be used to convey power, ground, signals, test points, and other voltage, current, data, or other information.

Various embodiments of the present invention may incorporate one or more of these and the other features described herein. A better understanding of the nature and advantages of the present invention may be gained by reference to the following detailed description and the accompanying drawings.

### BRIEF DESCRIPTION OF THE DRAWINGS

FIG. 1 illustrates a front view of a connector receptacle according to an embodiment of the present invention;

FIG. 2 illustrates a front view of a connector insert according to an embodiment of the present invention;

FIG. 3 illustrates a connector system according to an embodiment of the present invention;

FIG. 4 illustrates a connector system according to an embodiment of the present invention where the connectors are in an unmated state;

FIG. 5 illustrates a connector system according to an embodiment of the present invention where the connectors are mated;

FIG. 6 illustrates a connector system according to an embodiment of the present invention where the connectors are mated; and

FIG. 7 illustrates a connector system according to an embodiment of the present invention.

### DESCRIPTION OF EXEMPLARY EMBODIMENTS

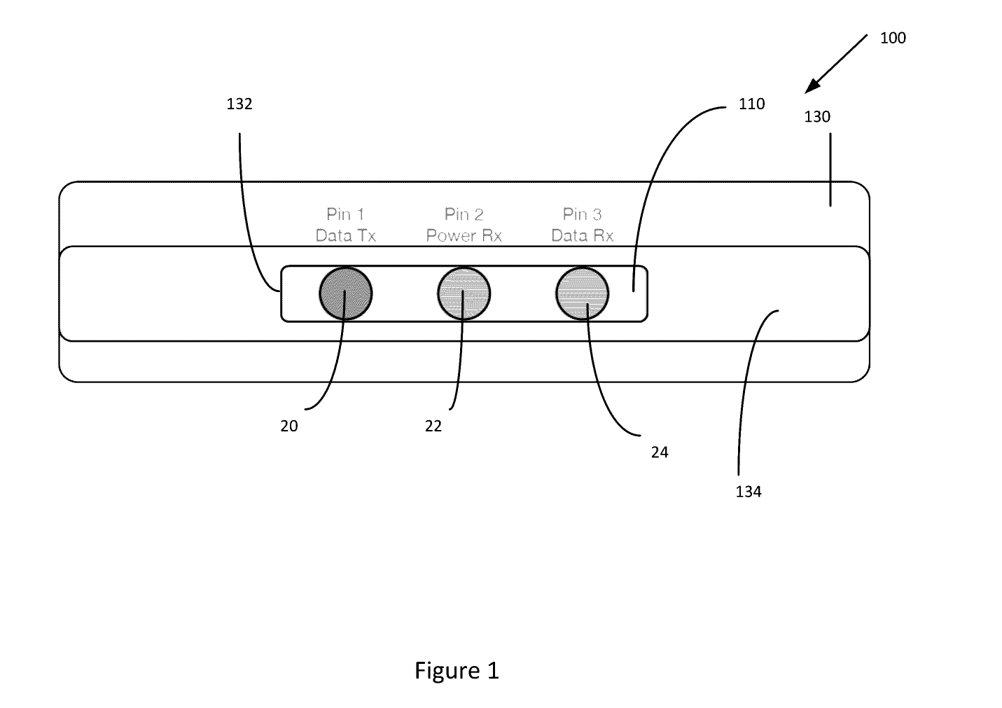

FIG. 1 illustrates a front view of a connector receptacle according to an embodiment of the present invention. This figure, as with the other included figures, is shown for illustrative purposes and does not limit either the possible embodiments of the present invention or the claims.

Connector receptacle 100 may include optical contacts 20, 22, and 24. One or more optical contacts 20, 22, and 24 may be a terminating end of a fiber-optic window. In this example, optical contact 20 may be used for transmitting data, optical contact 22 may be used for receiving power, and optical contact 24 may be used for receiving data. In these and other embodiments of the present invention, one or more optical contacts 20, 22, and 24 may be a top surface of a lens, where a bottom surface of the lens may be attached to or near a fiber-optic window.

An optical gasket 110 may surround sides of contacts 20, 22, and 24. Optical gasket 110 may form a seal around contacts 20, 22, and 24 to prevent moisture leakage into the electronic device housing this connector receptacle. Specifically, optical gasket 110 may form a seal around the lenses or ends of fiber-optic windows that form contacts 20, 22, and 24.

In these and other embodiments of the present invention, optical contacts 20, 22, and 24 may be formed as a single piece with optical gasket 110. For example, optical gasket 110 may be a single unit where contacts 20, 22, and 24 are transparent, and where surrounding areas of optical gasket 110 are opaque to reduce light leakage among the contacts. Fiber-optic windows may terminate at a bottom side of optical gasket 110 at positions corresponding to optical contacts 20, 22, and 24. In this example, optical contacts 20, 22, and 24 may be transparent and may be optically neutral or shaped to form lenses.

Connector receptacle 100 may be housed in an opening 132 in housing 130. Optical gasket 110 may form a seal with an inside edge of opening 132. In other embodiments of the present invention, optional gasket 110 may extend beyond and behind opening 132 and may be glued or otherwise held in place to form a seal between optical gasket 110 and device housing 130. An O-ring or second gasket may be used to further seal the optical gasket 110 to the device housing 130.

In various embodiments the present invention, connector receptacle 100 may be located in a groove or slot 134 in device housing 130 of an electronic device. Electronic device may be a portable computing device, tablet computer, desktop computer, laptop, all-in-one computer, wearable computing device, smart phone, storage device, portable media player, navigation system, monitor, power supply, adapter, remote control device, charger, or other device.

Again, conventional metallic contacts may be susceptible to corrosion. To reduce this corrosion, contacts may be formed of, or plated with, expensive precious metals. These metals may become scratched during use, thereby facilitating further corrosion of the contacts. Also, drops of water may adhere to surface contacts due to surface tension. When these contacts are made of metal, the drops may form electrical pathways between the contacts or between the contacts and the enclosure. This moisture, particularly in the presence of voltages on the contacts, may lead to electrochemical migration, otherwise known as dendritic growth, which may lead to the formation of electrical pathways between contacts and contacts in the enclosure.

Accordingly, embodiments of the present invention provide connector receptacles having optical contacts, such as optical contacts 20, 22, and 24. These optical contacts, whether they are lenses or ends of fiber-optic windows, may be formed of sapphire, polycarbonate, glass or other material. These materials may exhibit excellent corrosion resistance in the presence of moisture and other liquids. This may provide connector receptacles that are particularly well-suited to applications that require water resistance, such as where sweat accumulation or immersion in water may occur. These connector receptacles may be well-suited for use with implantable devices, submergible devices, wearable devices, and other types of devices.

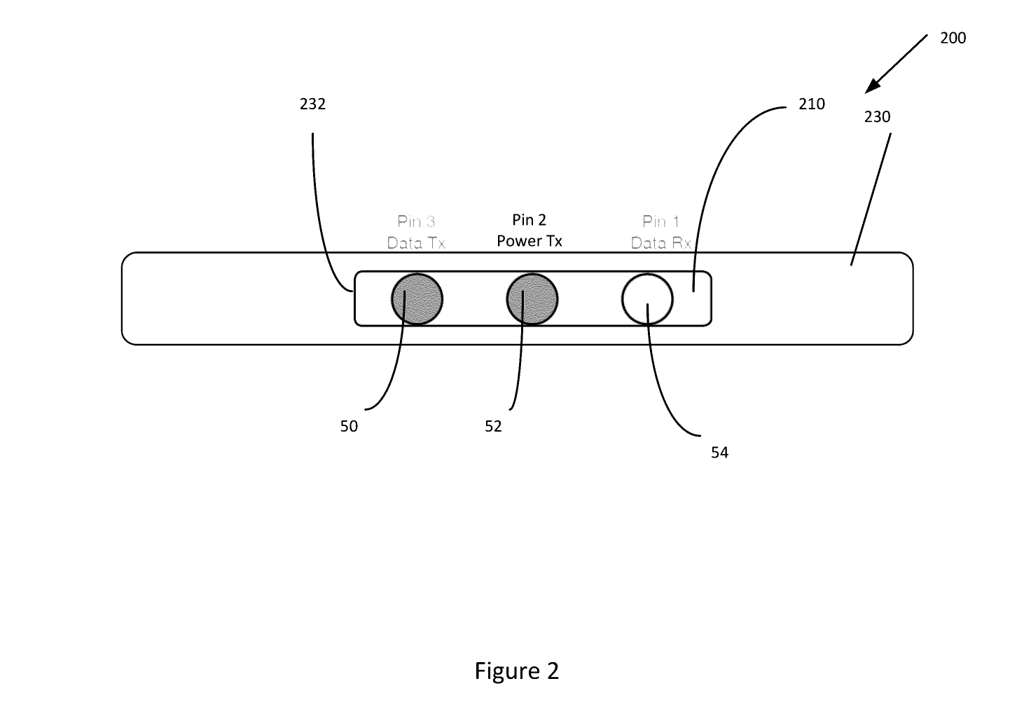

FIG. 2 illustrates a front view of a connector insert according to an embodiment of the present invention. Connector insert 200 may include optical contacts, such as optical contacts 50, 52, and 54. In this example, optical contact 50 may be used as a data transmission contact, optical contact 52 may be used as a power transmitting contact, while optical contact 54 may be used as a data receiving contacts. In this way, when connector insert 200 is mated with connector receptacle 100, optical contact 50 in connector insert 200 may provide data to optical contact 24 in connector receptacle 100, optical contact 20 in connector receptacle 100 may provide data to optical contact 54 in connector insert 200, and optical contact 52 in connector insert 200 may provide power to optical contact 22 in connector receptacle 100.

As in connector receptacle 100, one or more optical contacts 50, 52, and 54 may be a terminating end of a fiber-optic window. In these and other embodiments of the present invention, one or more optical contacts 50, 52, and 54 may be a top surface of a lens, where a bottom surface of the lens may be attached to or near a fiber-optic window.

An optical gasket 210 may surround sides of contacts 50, 52, and 54. Optical gasket 210 may form a seal around contacts 50, 52, and 54 to prevent moisture leakage into the connector insert. Specifically, optical gasket 210 may form a seal around the lenses or ends of fiber-optic windows that form contacts 50, 52, and 54.

In these and other embodiments of the present invention, optical contacts 50, 52, and 54 may be formed as a single piece with optical gasket 210. For example, optical gasket 210 may be a single unit where contacts 50, 52, and 54 are transparent and surrounding areas of optical gasket 210 are opaque to reduce light leakage between the contacts. Fiber-optic windows may terminate at a bottom side of optical gasket 210 at positions corresponding to optical contacts 50, 52, and 54. In this example, optical contacts 50, 52, and 54 may be transparent and may be optically neutral or shaped to form lenses.

Connector insert 200 may be housed in an opening 232 in housing 230. Optical gasket 210 may form a seal with an inside edge of opening 232. In other embodiments of the present invention, optional gasket 210 may extend beyond and behind opening 232 and may be glued or otherwise held in place to form a seal between optical gasket 210 and device housing 230. An O-ring or second gasket may be used to further seal the optical gasket 210 to the device housing 230. In various embodiments the present invention, connector insert 200 may be configured to fit in a groove or slot 134 in device housing 130 (shown in FIG. 1) of an electronic device.

Again, conventional metallic contacts may be susceptible to corrosion. Accordingly, embodiments of the present invention may provide connector inserts having optical contacts, such as optical contacts 50, 52, and 54. These optical contacts, whether they are lenses or ends of a fiber-optic window, may be formed of sapphire, polycarbonate, glass or other material. These materials may exhibit excellent corrosion resistance in the presence of moisture and other liquids. This may provide connector inserts that are particularly well-suited to applications that require water resistance, such as where sweat accumulation or immersion in water may occur. These connector inserts may be well-suited for use with implantable devices, submergible devices, wearable devices, and other types of devices.

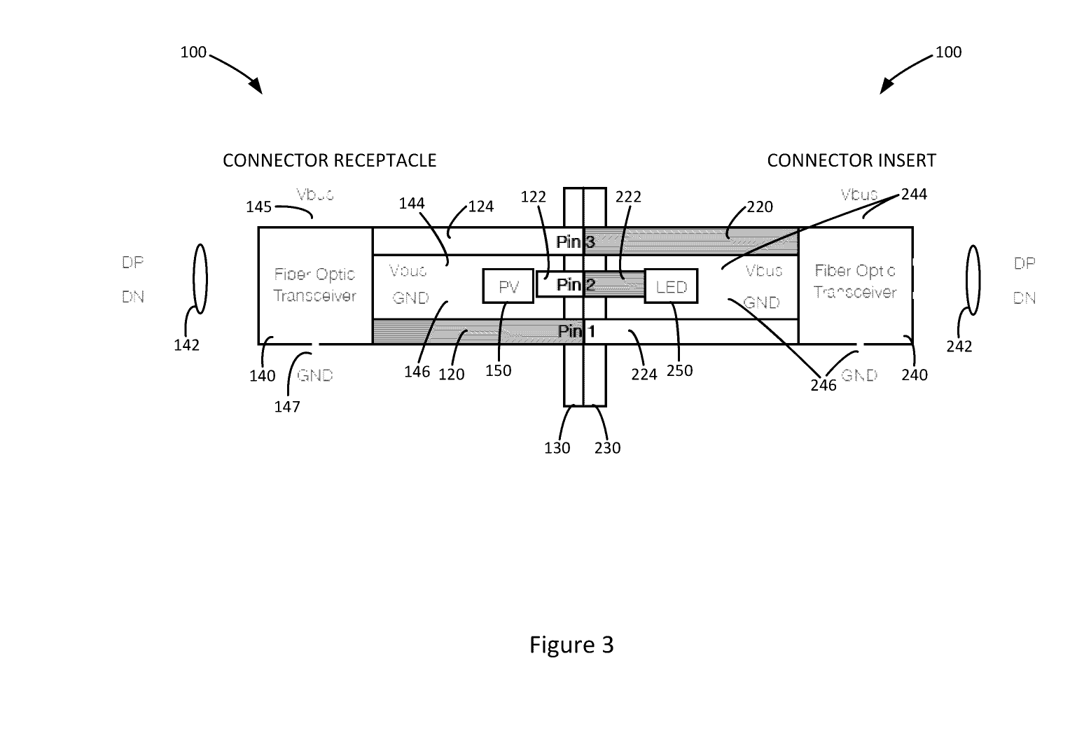

FIG. 3 illustrates a connector system according to an embodiment of the present invention. In this example, connector insert 200 is shown as being mated with connector receptacle 100. In this mated configuration, optical gasket 130 of connector receptacle 100 may be adjacent to, or near, optical gasket 230 in connector insert 200. Connector insert 200 may include fiber-optic transceiver 240. Fiber-optic transceiver 240 may include a transmitter optically coupled to a first end of fiber-optic window 220. The transmitters in transceivers 140 and 240 may include LEDs or other light-emitting devices. Data transmitted via fiber-optic window 220 may be received by fiber-optic window 124 in connector receptacle 100. Fiber-optic transceiver 140 may include a receiver optically coupled to a first end of fiber-optic window 124. The receivers in transceivers 140 and 240 may include photodiodes or other light-receiving devices. Using this path, connector insert 200 may provide data on lines 242 to connector receptacle 100 lines 142.

Similarly, fiber-optic transceiver 140 may include a transmitter coupled to a first end of fiber-optic window 120. Data transmitted via fiber-optic window 120 may be received at connector insert 100 by fiber-optic window 224. Fiber-optic transceiver 240 may include a receiver coupled to a first end of fiber-optic window 224. Using this path, connector receptacle 100 may provide data on lines 142 to connector insert 200 lines 242.

In this example, data may be transferred from connector receptacle 100 to connector insert 200 and from connector insert 200 to connector receptacle 100. In other embodiments of the present invention, these communications may be unidirectional, for example, from connector insert 200 to connector receptacle 100. In other embodiments of the present invention, one fiber-optic path may be used. Where one fiber-optic path is used, the connector receptacle 100 and connector insert 200 may communicate in an alternating half-duplex mode. In other embodiments of the present invention, a wavelength of light provided by fiber-optic transceiver 140 and fiber-optic transceiver 240 may be different and connector receptacle 100 and connector insert 200 may communicate in a full-duplex mode.

In this specific embodiment of the present invention, power may be provided by connector insert 200 to connector receptacle 100. In other embodiments of the present invention, power may be provided by connector receptacle 100 to connector insert 200, or power may be provided in either or both directions, depending on which connector has available power.

In this example, LED 250 in connector insert 200 may be powered and be optically coupled to a first end of fiber-optic window 222. LED 250 may be an LED, laser, infrared transmitter, or other light-emitting device. LED 250 may provide light over fiber-optic window 222, where it may be received by fiber-optic window 122. Photovoltaic cell 150 in connector receptacle 100 may be optically coupled to a first end or fiber-optic window 122. Photovoltaic cell 150 may provide power on line 144. Power on line 144 may be applied to fiber-optic transceiver 140 on line 145. Power on line 144 may be provided to other circuitry (not shown.)

In this example, contacts 20, 22, and 24 in FIG. 1 may be ends of fiber-optic windows 120, 122, and 124, respectively. Similarly, contacts 50, 52, and 54 in FIG. 2 may be ends of fiber-optic windows 220, 222, and 224, respectively. In other embodiments of the present invention, separate lenses or optically neutral covers may be attached to ends of fiber-optic windows 120, 122, 124, 220, 222, and 224.

In various embodiments of the present invention, various types of data may be transferred between connector receptacle 100 and connector insert 200. For example, connector insert 200 may provide firmware or software updates to an electronic device housing connector receptacle 100. In these and other embodiments of the present invention, circuitry associated with connector insert 200 may extract logs or usage data from an electronic device housing connector receptacle 100. In these and other embodiments of the present invention, connector insert 200 may be connected to test equipment that may test an electronic device housing connector receptacle 100.

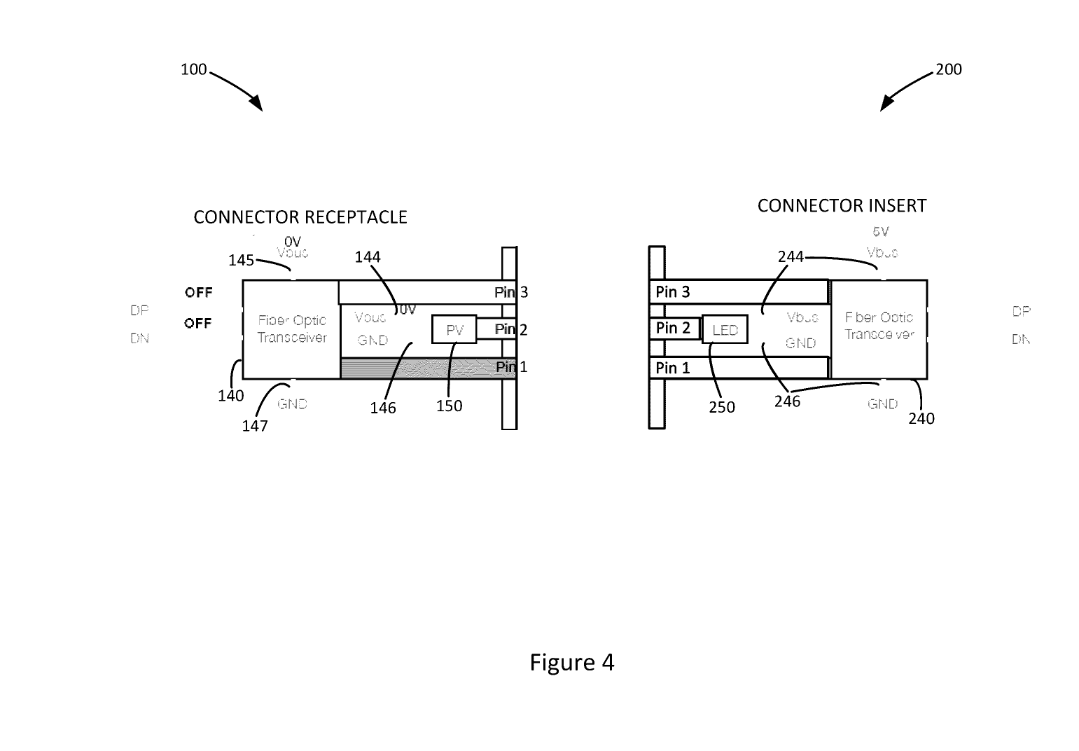

FIG. 4 illustrates a connector system according to an embodiment of the present invention where the connectors are in an unmated state. In this example, power on terminals 244 and 246 may be applied to LED 250 in connector insert 200. Connector receptacle 100 may be housed in a device where an internal battery is discharged. In this state, power on lines 144 and 145 may be at a ground potential and fiber-optic transceiver 140 and photovoltaic cell 150 may be off.

In this example, connector insert 200 is not mated with connector receptacle 100. Accordingly, light emitted by LED 250 may be accidentally directed or reflected into a user's eye. In order to avoid injury, LED 250 may be initially powered in a low-power state. After communications with connector receptacle 100 are established, the power to LED 250 may be increased. In other embodiments of the present invention, after communications are established, connector receptacle 100 may inform connector insert 200 that the device that houses connector receptacle 100 is powered. In this case, LED 250 may remain in the low power state or may be shut off to conserve power and lengthen the life of LED 250.

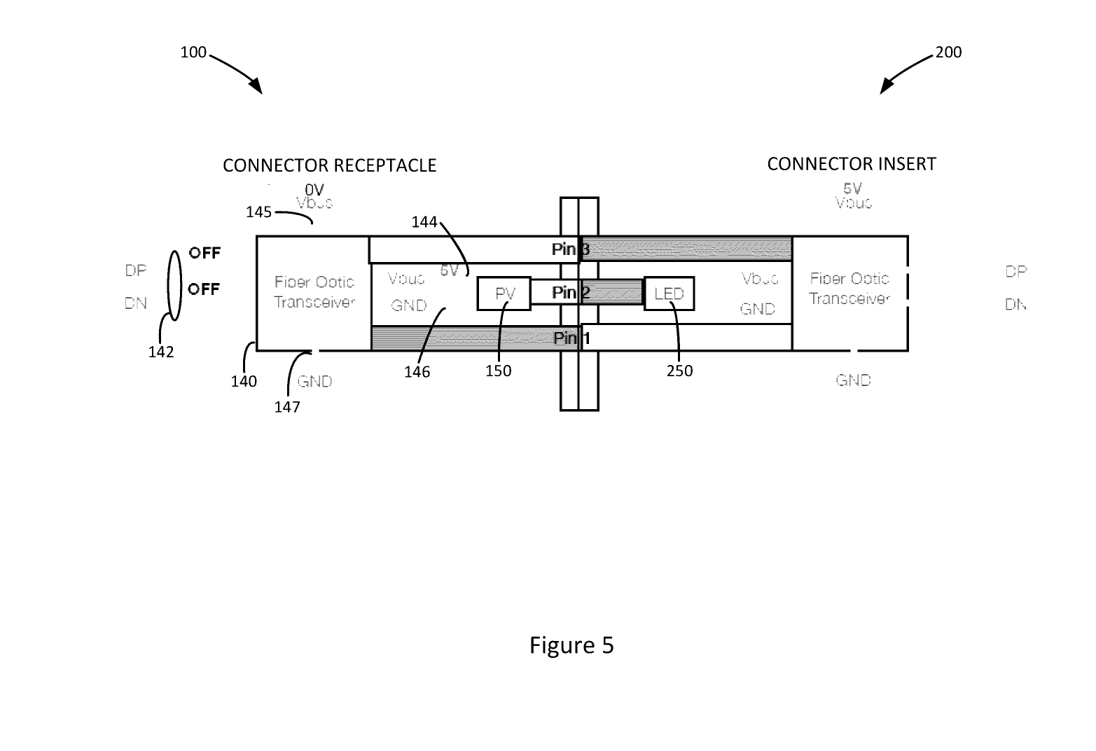

FIG. 5 illustrates a connector system according to an embodiment of the present invention where the connectors are mated. In this example, LED 250 may provide light to photovoltaic cell 150. Photovoltaic cell 150 may generate a power supply on line 144. The power supplied to line 144 may generate charge sufficient to power fiber-optic transceiver 140 and other associated circuitry (not shown.) This is shown in the following figure.

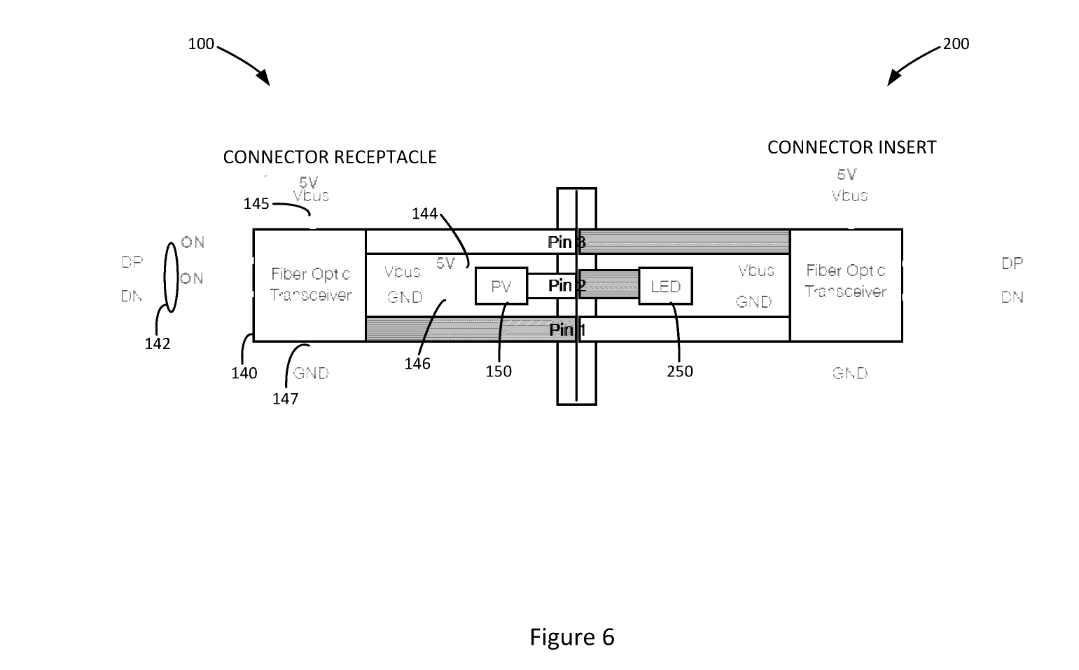

FIG. 6 illustrates a connector system according to an embodiment of the present invention where the connectors are mated. In this example, LED 250 may provide light to photovoltaic cell 150. Photovoltaic cell 150 may generate a power supply on line 144, which may be used to power fiber-optic transceiver 140 over line 145. In other embodiments of the present invention, photovoltaic cell 150 may power fiber-optic transceiver 140 directly. Other circuitry that may be used to drive and receive signals on electrical lines 142 may be powered by photovoltaic cell 150 as well. An example of this circuitry is shown in the following figure.

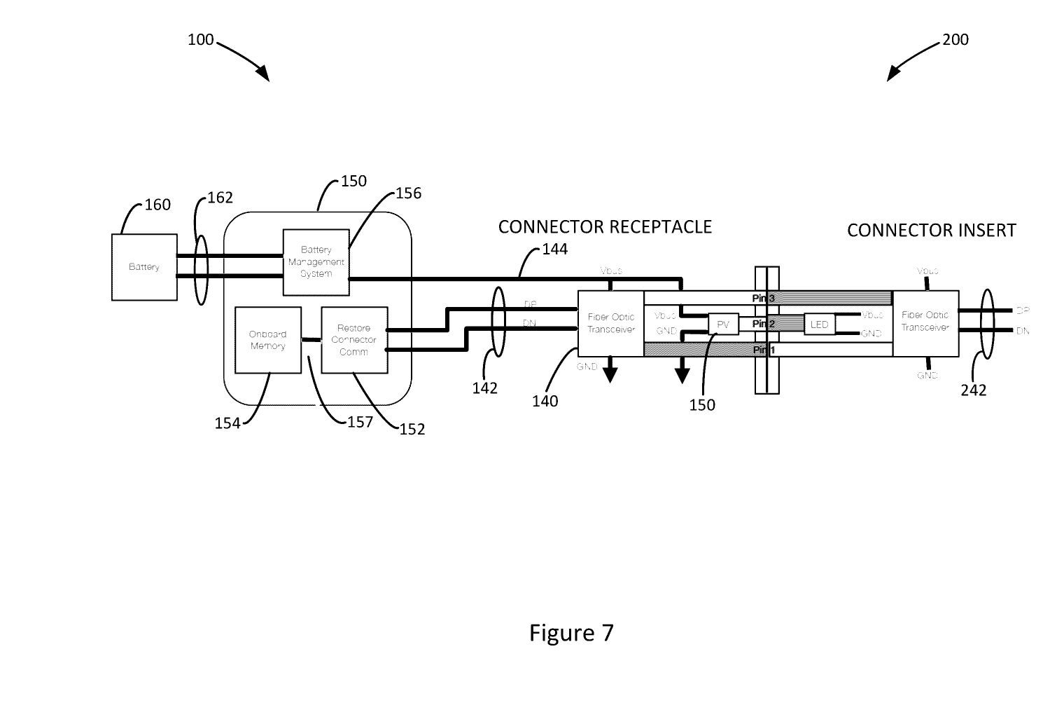

FIG. 7 illustrates a connector system according to an embodiment of the present invention. In this example, connector receptacle 100 may be mated with connector insert 200. Connector receptacle 100 may include fiber-optic transceiver 140 that may be in communication over electrical lines 142 with input/output circuitry 152. Input/output circuitry 152 may write to and read date from memory 154. Charge developed by photovoltaic cell 150 may be provided on line 144 to battery management system 156. Battery management circuitry 156 may charge battery 160 over lines 162. Input-output circuitry 152, memory 154, and battery management system 156 may be located in a module or other circuit component 150.

In this embodiment of the present invention, connector receptacle 100 and connector insert 200 may convert electrical signals on lines 142 and 242 to fiber-optic signals and back again. These electrical signals on lines 142 and 242 may be USB signals or other types of signals.

In various embodiments of the present invention, the fiber-optic windows, the one or more transparent coverings or lenses, and other optically conductive components may be formed using sapphire, polycarbonate, glass or other material. The optical gaskets and other optically nonconductive components may be formed of silicone, plastic, or other material. These may be formed by injection molding or other process. Electrically conductive portions of connector receptacles may be formed by stamping, metal-injection molding, machining, micro-machining, 3-D printing, or other manufacturing process. The electrically conductive portions may be formed of stainless steel, steel, copper, copper titanium, phosphor bronze, or other material or combination of materials. They may be plated or coated with nickel, gold, or other material. Nonconductive portions may be formed using injection or other molding, printing, 3-D printing, machining, or other manufacturing process. The nonconductive portions may be formed of silicon or silicone, rubber, hard rubber, plastic, nylon, liquid-crystal polymers (LCPs), ceramics, or other nonconductive material or combination of materials.

Embodiments of the present invention may provide connector receptacles that may be located in, and may connect to, various types of devices, such as portable computing devices, tablet computers, desktop computers, laptops, all-in-one computers, wearable computing devices, smart phones, storage devices, portable media players, navigation systems, monitors, power supplies, adapters, remote control devices, chargers, and other devices. These connector receptacles may provide pathways for signals that are compliant with various standards such as Universal Serial Bus (USB), High-Definition Multimedia Interface® (HDMI), Digital Visual Interface (DVI), Ethernet, DisplayPort, Thunderbolt™, Lightning™, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. In various embodiments of the present invention, these interconnect paths provided by these connector receptacles may be used to convey power, ground, signals, test points, and other voltage, current, data, or other information.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A connector receptacle comprising:
a first fiber-optic window having a first end and a second end;
a fiber-optic receiver optically connected to a first end of the first fiber-optic window;
a second fiber-optic window having a first end and a second end;
a photovoltaic cell optically connected to a first end of the second fiber-optic window; and
a first circuit coupled to receive power from the photovoltaic cell.

2. The connector receptacle of claim 1 further comprising:
a first lens having a top, bottom, and a sidewall joining the top and bottom, the bottom of the first lens adjacent to the second end of the first fiber-optic window; and
a second lens having a top, bottom, and a sidewall joining the top and bottom, the bottom of the second lens adjacent to the second end of the second fiber-optic window.

3. The connector receptacle of claim 2 further comprising:
an optical gasket around the sidewalls of the first and second lenses.

4. The connector receptacle of claim 1 further comprising:
a third fiber-optic window having a first end and a second end;
a fiber-optic transmitter optically connected to a first end of the third fiber-optic window.

5. The connector receptacle of claim 4 further comprising:
a first lens having a top, bottom, and a sidewall joining the top and bottom, the bottom of the first lens adjacent to the second end of the first fiber-optic window;
a second lens having a top, bottom, and a sidewall joining the top and bottom, the bottom of the second lens adjacent to the second end of the second fiber-optic window; and
a third lens having a top, bottom, and a sidewall joining the top and bottom, the bottom of the third lens adjacent to the second end of the third fiber-optic window.

6. The connector receptacle of claim 5 further comprising:
an optical gasket around the sidewalls of the first, second, and third lenses.

7. The connector receptacle of claim 4 wherein the first circuit is an input/output circuit.

8. The connector receptacle of claim 7 wherein the input/output circuit is coupled to a memory.

9. A connector insert comprising:
a first fiber-optic window having a first end and a second end;
a fiber-optic transmitter optically connected to a first end of the first fiber-optic window;
a second fiber-optic window having a first end and a second end; and
a light-emitting device optically connected to a first end of the second fiber-optic window.

10. The connector insert of claim 9 wherein the light-emitting device is a light-emitting diode.

11. The connector insert of claim 9 wherein the light-emitting device is a laser.

12. The connector insert of claim 9 further comprising:
a first lens having a top, bottom, and a sidewall joining the top and bottom, the bottom of the first lens adjacent to the second end of the first fiber-optic window; and
a second lens having a top, bottom, and a sidewall joining the top and bottom, the bottom of the second lens adjacent to the second end of the second fiber-optic window.

13. The connector insert of claim 12 further comprising:
an optical gasket around the sidewalls of the first and second lenses.

14. The connector insert of claim 9 further comprising:
a third fiber-optic window having a first end and a second end;
a fiber-optic receiver optically connected to a first end of the third fiber-optic window.

15. The connector insert of claim 14 further comprising:
a first lens having a top, bottom, and a sidewall joining the top and bottom, the bottom of the first lens adjacent to the second end of the first fiber-optic window;
a second lens having a top, bottom, and a sidewall joining the top and bottom, the bottom of the second lens adjacent to the second end of the second fiber-optic window; and
a third lens having a top, bottom, and a sidewall joining the top and bottom, the bottom of the third lens adjacent to the second end of the third fiber-optic window.

16. The connector insert of claim 15 further comprising:
an optical gasket around the sidewalls of the first, second, and third lenses.

17. A connector system comprising:
a connector receptacle comprising:
a first fiber-optic window having a first end and a second end;
a second fiber-optic window having a first end and a second end;
a fiber-optic transceiver optically connected to a first end of the first fiber-optic window and a first end of the second fiber-optic window;
a third fiber-optic window having a first end and a second end;
a photovoltaic cell optically connected to a first end of the third fiber-optic window; and
a first circuit coupled to receive power from the photovoltaic cell; and
a connector insert comprising:
a first fiber-optic window having a first end and a second end;
a second fiber-optic window having a first end and a second end;
a fiber-optic transceiver optically connected to a first end of the first fiber-optic window and a first end of the second fiber-optic window;
a third fiber-optic window having a first end and a second end; and
a light-emitting device optically connected to a first end of the third fiber-optic window.

18. The connector system of claim 17 wherein the light-emitting device is a light-emitting diode.

19. The connector system of claim 17 wherein the light-emitting device is a laser.

20. The connector insert of claim 15 wherein the connector receptacle further comprises:
a first lens having a top, bottom, and a sidewall joining the top and bottom, the bottom of the first lens adjacent to the second end of the first fiber-optic window;
a second lens having a top, bottom, and a sidewall joining the top and bottom, the bottom of the second lens adjacent to the second end of the second fiber-optic window; and
a third lens having a top, bottom, and a sidewall joining the top and bottom, the bottom of the third lens adjacent to the second end of the third fiber-optic window; and
an optical gasket around the sidewalls of the first, second, and third lenses.
